(19) United States
(12) Patent Application Publication
(10) Pub. No.: US 2021/0028854 A1
(43) Pub. Date: Jan. 28, 2021

(54) Method of spatial signal separation for wireless communication systems

(71) Applicant: John Elton Piper, Panama City Beach, FL (US)

(72) Inventor: John Elton Piper, Panama City Beach, FL (US)

(21) Appl. No.: 16/435,452

(22) Filed: Jun. 7, 2019

(51) Int. Cl. H04B 7/08; H04B 7/06; H04B 7/0456; G06F 17/16

(52) U.S. Cl. CPC H04B 7/0854; G06F 17/16; H04B 7/0456; H04B 7/0634

(57) ABSTRACT

In a multiple signal wireless communication system, it is important to be able to effectively separate signals. This separation has traditionally been accomplished in the frequency and time domains. High resolution spatial signal separation can also be accomplished with a small number of antennas by following the proper mathematical method. This involves modeling multiple communication signals that map onto an antenna array in the receive case and by modeling the multiple antenna output signals that form multiple transmit signals. Inverting these processes by use of the Moore-Penrose inverse results in complete spatial separation of the signals of interest. This novel method has important applications in wireless communication systems.

### RELATED U.S. APPLICATION DATA

Continuation-in-part of application Ser. No. 16/296,146 filed on Mar. 7, 2019

### BACKGROUND OF THE INVENTION

Signal separation is an important problem in wireless communication systems. A simple solution is to separate the signals in frequency and let the receiver tune into the signal of interest. This method is called frequency division multiple access (FDMA). The rapid proliferation of users in cellular phone networks has required increasingly sophisticated methods of signal separation to keep up with demand.

One popular solution is called code division multiple access (CDMA). This approach allows multiple users to share the same frequency region by coding the signals such that they do not interfere. Sprint and Verizon networks have used this approach.

An alternative solution is called time division multiple access (TDMA). This approach also allows multiple users to share the same frequency region by allocating specific time slots for users to send and receive. The Global System for Mobile communications (GSM) has used this approach in its first two generations. AT&T and T-Mobile networks along with most of the world now use the latest version of GSM which is a combination of coded frequency division and time division.

An additional solution to increase capacity is called spatial division multiple access (SDMA). Cellular base station towers typically have three sets of antennas whose directionality provides a form of spatial division. The three areas around the tower are described as cells. A network of towers is designed to provide continuous coverage from cell to cell. Multiple users within each cell are continuously allocated various frequency bins and time slots for voice and data. It is possible to increase capacity within each cell by efficient spatial separation of users with the use of an array of antennas. This is discussed by Roy, Spatial Division Multiple Access Technology and Its Application to Wireless Communication Systems, 1997 47^{th} Vehicular Technology Conference, Phoenix.

Antenna array processing has a history that goes back over 100 years and is still an active area of research interest. It is a vast subject that has applications in detection, imaging, and communications. Spatial separation methods used are typically called beamforming. The essence of beamforming is to focus the beam in the desired direction and not allow signals from undesired directions.

The problem with conventional array processing is that beampatterns associated with a small number of antennas typically have a broad main lobe and the sidelobes allow unwanted leakage from or into other directions. Thus, this approach generally lacks the spatial resolution required to effectively separate signals. The underlying problem with conventional array processing is that it is implicitly based on a one-signal model. Of course, with one signal neither the main lobe or sidelobe structure matters.

The optimal solution in a multiple signal environment is to explicitly include multiple signals in the signal model. This can effectively yield complete separation or decoupling of the signals of interest even with a small number of antennas. A related sonar application issue is discussed in Piper and Roberts, On the Number of Signals Resolvable by an Array, OCEANS 2010, Seattle.

It should be noted that as communication frequencies increase the antenna sizes decrease in size and efficiency. To increase reception efficiency, it is necessary to increase the number of antennas in the array. This presents an opportunity for advanced array processing methods.

An important part of all methods that attempt to spatially separate signals is to accurately know the direction of arrival of the various signals. This has been a long-studied problem and many techniques have been developed to accurately estimate the direction of arrival of signals. Maximum likelihood methods are an optimal solution, and an example is described in Ziskind and Wax, Maximum Likelihood Localization of Multiple Sources by Alternating Projection, IEEE Transactions on Acoustics, Speech, and Signal Processing, Oct. 1988.

### BRIEF SUMMARY OF THE INVENTION

The utility of this method is complete spatial separation of multiple wireless communication signals. The novelty of this method is the use of the Moore-Penrose inverse in the separation process of multiple signals. For reception the signals measured from the antenna array are mapped onto a signal space in which valid and unwanted signals are completely decoupled. For transmission the antenna output signals are used to transmit specific signals in the direction of specific users and transmit null signals into unwanted directions. These approaches are both mathematically elegant and powerful.

One embodiment of this method begins by constructing a mathematical model that explicitly assumes N signals, s(t), are received by an array of M antennas. This mapping can be mathematically represented by the following equation:

$$( \begin{matrix}{a}_{1} ( t ) \\ {a}_{2} ( t ) \\ {a}_{3} ( t ) \\ ⋮ \\ {a}_{M} ( t )\end{matrix} ) = ( \begin{matrix}1 & 1 & 1 & … & 1 \\ {Δ}_{12} & {Δ}_{22} & {Δ}_{32} & & {Δ}_{N 2} \\ {Δ}_{13} & {Δ}_{23} & {Δ}_{33} & & {Δ}_{N3} \\ ⋮ & ⋮ & ⋮ & … & ⋮ \\ {Δ}_{1 M} & {Δ}_{2 M} & {Δ}_{3 M} & & {Δ}_{NM}\end{matrix} ) ( \begin{matrix}{s}_{1} ( t ) \\ {s}_{2} ( t ) \\ {s}_{3} ( t ) \\ ⋮ \\ {s}_{N} ( t )\end{matrix} )$$

### Where,

sⱼ(t)=j^{th} signal which can be direct path, multipath, or interference
aₖ(t)=k^{th} antenna received signal
Δⱼₖ=mapping (delay) of j^{th} signal onto k^{th} antenna

Inspection of the above equation shows that every antenna will receive all the signals at various delays. To correctly separate this tangle of signals it is necessary to invert the above equation. The Moore-Penrose inverse can perform this inversion in a least-squares sense.

It is convenient to call the signal vector, s, the measured antenna signal vector, a, and the mapping or delay or steering matrix, D. the above equation can then be compactly written as:

a=Ds

The Moore-Penrose then requires the above equation be left multiplied by D⁵⁵⁴ , the transpose with delays reversed of D.

D^{†}a=D^{†}Ds

This equation is then left multiply by (D^{†}D)⁻¹ which yields the signal vector from the measured antenna outputs.

s=(D^{†}D)⁻¹D^{†}a

It is important to note that in this representation all of the signals are effectively in their own dimensional space and are completely decoupled from other signals. Traditional array processing is based on simply steering the array towards the direction of interest, which is what the D^{†} a term does. This new method additionally includes the (D^{†}D)⁻¹ term, which mathematically separates the signals and can be thought of as an inner product metric. In practical terms this metric can be thought of as a two-dimensional matrix of amplitudes and delays or phase shifts that are applied to the Dt a vector. So, this new method can be thought of as an extension of traditional methods.

The second embodiment of signal separation involves the process of signal transmission into specific directions, which can be thought of as the functional inverse of the above reception process. This method begins by constructing a mathematical model that explicitly assumes N signals, s(t), are transmitted by an array of M antennas. This mapping can be mathematically represented by the following equation:

$$( \begin{matrix}{s}_{1} ( t ) \\ {s}_{2} ( t ) \\ {s}_{3} ( t ) \\ ⋮ \\ {s}_{N} ( t )\end{matrix} ) = ( \begin{matrix}1 & - {Δ}_{21} & - {Δ}_{31} & … & - {Δ}_{M 1} \\ 1 & - {Δ}_{22} & - {Δ}_{32} & & - {Δ}_{M 2} \\ 1 & - {Δ}_{23} & - {Δ}_{33} & & - {Δ}_{M 3} \\ ⋮ & ⋮ & ⋮ & … & ⋮ \\ 1 & - {Δ}_{2 N} & - {Δ}_{3 N} & & - {Δ}_{MN}\end{matrix} ) ( \begin{matrix}{a}_{1} ( t ) \\ {a}_{2} ( t ) \\ {a}_{3} ( t ) \\ ⋮ \\ {a}_{M} ( t )\end{matrix} )$$

### Where,

sⱼ(t)=desired signal transmitted into the j^{th} direction
aₖ(t)=k^{th} antenna transmit signal
Aⱼₖ=mapping (delay) of k^{th} antenna output into j^{th} signal direction

Inspection of the above equation shows that every signal is the summation of all the antenna outputs at various delays. The above mapping or steering matrix can be seen to be the transpose of the receive case with the delays reversed. The signals and their directions are assumed to be known. To calculate the M antenna transmit signals it is necessary to invert the above equation. Again, the Moore-Penrose inverse can perform this inversion in a least-squares sense.

It is convenient to call the desired signal vector, s, the antenna transmit signal vector, a, and the transmission mapping or delay or steering matrix, D^{†}. The above transmission matrix equation can then be compactly written as:

s=D^{†}a

The Moore-Penrose inverse then requires the above equation be left multiplied by D.

D s=D D^{†}a

This equation is then left multiplied by (D D^{†})⁻¹ which yields the antenna array transmit signal vector, a, from the desired signals, s.

a=(D D^{†})⁻¹ Ds

It is important to note that in this representation all of the signals are completely decoupled from other signals. Traditional array processing is based on simply steering the array towards the direction of interest, which is what the D s term does. This method additionally includes the (D D^{†})⁻¹ term, which mathematically separates the signals and can be thought of as an inner product metric. In practical terms this metric can be thought of as a two-dimensional matrix of amplitudes and delays or phase shifts that are applied to the D s vector. So, this transmission method can also be thought of as an extension of traditional methods.

According to this invention, conventional beamforming methods, which typically are based on mathematical methods that implicitly assume a one-signal source, can be replaced by a beamformer that assumes multiple-signal received from or transmitted into different directions. These spatially separated signals are mathematically decoupled from each other which effectively allows more users and capacity in a given cell.

Therefore, it is an object of the present invention to provide for increased capacity of wireless communication systems by spatial separation of signals in both receive and transmit modes. These advantages and objects of the present invention will become apparent from the following detailed description.

### BRIEF DESCRIPTION OF THE DRAWINGS

FIG. 1. Spatial signal separation example for reception.

FIG. 2. Spatial signal separation example for transmission.

### DETAILED DESCRIPTION OF THE INVENTION

The present invention provides for a method to spatially separate multiple signals in wireless communication receive and transmit systems. Complete separation of these signals requires a novel method that utilizes the Moore-Penrose inverse to spatially decouple all of the signals into orthogonal signal spaces. These include both the valid communication signals and any other signals at that frequency coming from other defined directions.

Signal separation is important in a variety of communication systems. One example is the communication between cell phones and base stations. The base station is designed to both receive and transmit signals to multiple cell phones. Likewise, military communications would benefit by spatially separating multiple signals on receive and transmit. Internet routers can also enhance signals to multiple devices using this method.

Reception of Signals

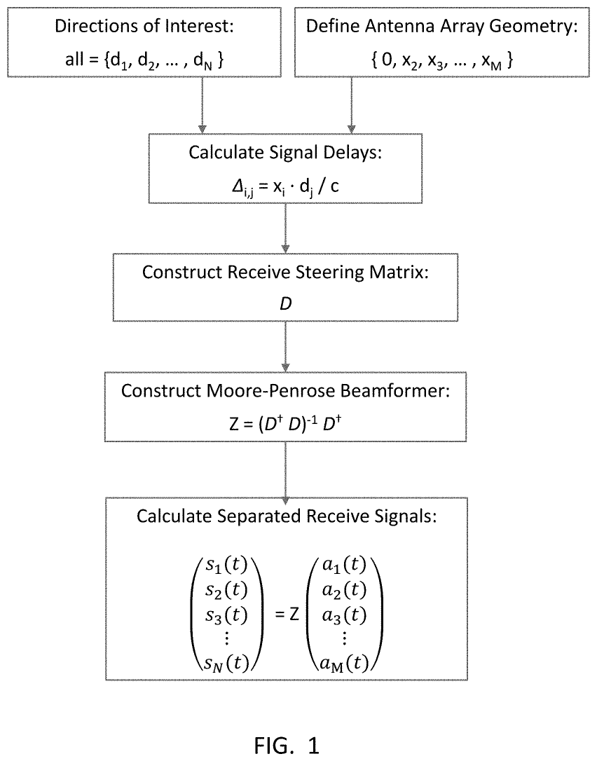

In a multiple signal environment best results can only be obtained by starting with a multiple signal model. Details of this method for reception are shown in the flow diagram labeled FIG. 1. Here it is assumed that there are N signals, {s₁, s₂, . . . , s_{N}}, measured by an array of M antenna. It is assumed that there are N−I valid signals, {s₁, s₂, . . . , s_{N-I}}, and signals N−I+1 through N, {s_{N-I+1}, . . . , s_{N}}, are assumed to be unwanted interference signals, multipath signals, or out-of-cell signals.

It is assumed that the N directions of arrival of the signals are known. The direction-of-arrival unit vectors, {d₁, d₂, . . . , d_{N}}, can be divided into N−I valid signals, {d₁, d₂, . . . , d_{N-I}}, and I unwanted interference signals, {d_{N-I+1}, . . . , d_{N}}. The direction of arrival of the signals may be known from the GPS location of the cell phones, by traditional direction-of-arrival techniques determined by the antenna array, or perhaps the directions of arrival are known a priori.

For M antennas in the array, it is convenient to refer to the first antenna as the origin. The geometry of the array can then be specified as {0, x₂, x₃, . . . , x_{M}} where the x vectors indicate the direction and distance from the origin to the antennas in the array. It is an important consideration for the system designer that the maximum number of spatially resolvable signals by an array is the number of antennas, M.

The time delay, Δᵢⱼ, associated with the j^{th} signal onto the i^{th} antenna is simply the dot product of the signal unit direction vector, dⱼ, and the antenna geometry vector, xᵢ, divided by the speed of light:

Δ_{i,j}=xᵢ·dⱼ/c

It should be noted that the time delays should be thought of as operators. Their operation is to shift the measured signals in time. It is possible to do this using analog techniques. It is also possible to do this in the digital domain. This is discussed by Piper in Exact and Approximate Time-Shift Operators, SPIE DSS, 2009, Orlando. If the signals are narrowband, then the time shifts are typically expressed as phase shifts.

These time delays are used to construct the steering matrix:

$$D = ( \begin{matrix}1 & 1 & 1 & … & 1 \\ {Δ}_{12} & {Δ}_{22} & {Δ}_{32} & & {Δ}_{N 2} \\ {Δ}_{13} & {Δ}_{23} & {Δ}_{33} & & {Δ}_{N3} \\ ⋮ & ⋮ & ⋮ & … & ⋮ \\ {Δ}_{1 M} & {Δ}_{2 M} & {Δ}_{3 M} & & {Δ}_{NM}\end{matrix} )$$

The Moore-Penrose inverse, Z, can then be constructed from the steering matrix:

Z=(D^{†}D)⁻¹D^{†}

Separating the signals from the antenna array data is the job of the Moore-Penrose inverse. Mathematically, the vector of the individual signals, s, is obtained by multiplying the Moore-Penrose inverse matrix, Z, and the vector of the individual antenna outputs, a.

$$( \begin{matrix}{s}_{1} ( t ) \\ {s}_{2} ( t ) \\ {s}_{3} ( t ) \\ ⋮ \\ {s}_{N} ( t )\end{matrix} ) = Z ( \begin{matrix}{a}_{1} ( t ) \\ {a}_{2} ( t ) \\ {a}_{3} ( t ) \\ ⋮ \\ {a}_{M} ( t )\end{matrix} )$$

Thus, the first signal stream is simply the elements of the first row of the Moore-Penrose inverse matrix times the outputs of the antenna array vector. The second signal stream is simply the elements of the second row of the Moore-Penrose inverse matrix times the outputs of the antenna array vector. The third signal stream is simply the elements of the third row of the Moore-Penrose inverse matrix times the outputs of the antenna array vector. And so forth until all the communication signals are calculated. These multiply and add operations can be easily performed using dedicated DSP or FPGA chips.

Since only the valid signals are generally desired, {s₁, s₂, . . . , s_{N-I}}, it is possible to eliminate the calculations associated with the unwanted signals by only calculating the desired signals. This is accomplished by observing that only the first N−I rows of the Moore-Penrose inverse matrix, Z, are required for this calculation. Thus, the Z matrix can be partitioned to only include the first N−I rows. This partitioned matrix, Z_{N-I×M}, reduces the computational costs in computing only the desired signals.

$$( \begin{matrix}{s}_{1} ( t ) \\ {s}_{2} ( t ) \\ {s}_{3} ( t ) \\ ⋮ \\ {s}_{N - I} ( t )\end{matrix} ) = {Z}_{N - IxM} ( \begin{matrix}{a}_{1} ( t ) \\ {a}_{2} ( t ) \\ {a}_{3} ( t ) \\ ⋮ \\ {a}_{M} ( t )\end{matrix} )$$

### Transmission of Signals

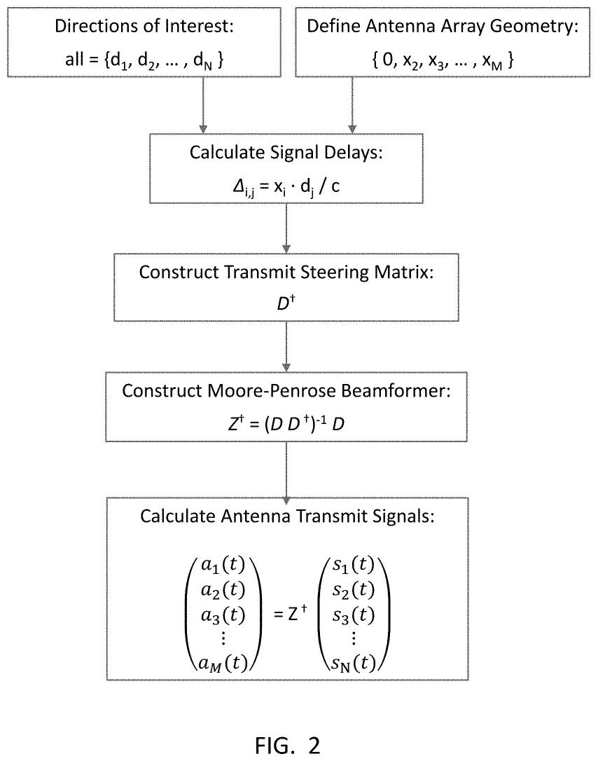

The method for transmission of signals can be thought of as the functional inverse of the reception of signals. Details of this method for transmission are shown in the flow diagram labeled FIG. 2. Again, it is assumed that there are N signals, {s₁, s₂, . . . , s_{N}}, to be transmitted by an array of M antennas. It is assumed that there are N−I specific signals to be transmitted, {s₁, s₂, . . . , s_{N-I}}, and signals N−I+1 through N, {s_{N-I+1}, . . . , s_{N}}are effectively null signals to be transmitted into directions where no signal is desired.

It is assumed that the N directions of transmission of the signals are known. The direction-of-transmission unit vectors, {d₁, d₂, . . . , d_{N}}, can be divided into N−I specific signals, {d₁, d₂, . . . , d_{N-I}}, and I null signals, {d_{N-I+1}, . . . , d_{N}}.

For the M antennas in the array, it is convenient to refer to the first antenna as the origin. The geometry of the array can then be specified as {0, x₂, x₃, . . . , x_{M}} where the x vectors indicate the direction and distance from the origin to the antennas in the array.

The time delay, Δᵢⱼ, associated with the j^{th} signal from the i^{th} antenna is simply the dot product of the signal unit direction vector, dⱼ, and the antenna geometry vector, xᵢ, divided by the speed of light:

Δᵢⱼ=xᵢ·dⱼ/c

These time delays are used to construct the transmission steering matrix:

$${D}^{†} = ( \begin{matrix}1 & - {Δ}_{21} & - {Δ}_{31} & … & - {Δ}_{M 1} \\ 1 & - {Δ}_{22} & - {Δ}_{32} & & - {Δ}_{M 2} \\ 1 & - {Δ}_{23} & - {Δ}_{33} & & - {Δ}_{M 3} \\ ⋮ & ⋮ & ⋮ & … & ⋮ \\ 1 & - {Δ}_{2 N} & - {Δ}_{3 N} & & - {Δ}_{MN}\end{matrix} )$$

This matrix maps the antenna array outputs to the signals projected or transmitted into the specified directions:

$$( \begin{matrix}{s}_{1} ( t ) \\ {s}_{2} ( t ) \\ {s}_{3} ( t ) \\ ⋮ \\ {s}_{N} ( t )\end{matrix} ) = {D}^{†} ( \begin{matrix}{a}_{1} ( t ) \\ {a}_{2} ( t ) \\ {a}_{3} ( t ) \\ ⋮ \\ {a}_{M} ( t )\end{matrix} )$$

In the transmission case the directions and signals are known. So, in order to solve for the antenna array outputs it is necessary to invert the above equation. As previously shown, this can be done in a least-squares sense by using the transmission Moore-Penrose inverse, Z^{†}. This can then be constructed from the steering matrix:

Z^{†}=(D D^{†})⁻¹D

Which yields:

$$( \begin{matrix}{a}_{1} ( t ) \\ {a}_{2} ( t ) \\ {a}_{3} ( t ) \\ ⋮ \\ {a}_{M} ( t )\end{matrix} ) = {Z}^{†} ( \begin{matrix}{s}_{1} ( t ) \\ {s}_{2} ( t ) \\ {s}_{3} ( t ) \\ ⋮ \\ {s}_{N} ( t )\end{matrix} )$$

Thus, the first antenna output signal is simply the elements of the first row of the transmission Moore-Penrose inverse matrix times the outputs of the signal vector. The second antenna output signal is simply the elements of the second row of the Moore-Penrose inverse matrix times the outputs of the signal vector. The third antenna output signal is simply the elements of the third row of the Moore-Penrose inverse matrix times the outputs of the signal vector. And so forth until all the antenna output signals are calculated. These multiply and add operations can be easily performed using dedicated DSP or FPGA chips.

Since the null signals are all zeros, the above calculation can be written more compactly and save computations. First, the signal vector can be rewritten to only include the specific signals and none of the null signals. Therefore, the signal vector can be collapsed to length N−I. Secondly, the transmission Moore-Penrose inverse matrix, Z^{†}, can be partitioned to only include the first N−I columns. It is convenient to denote this reduced column transmission Moore-Penrose inverse matrix as Z^{†}_{M×N-I}. Now the antenna output vector can be efficiently calculated as:

$$( \begin{matrix}{a}_{1} ( t ) \\ {a}_{2} ( t ) \\ {a}_{3} ( t ) \\ ⋮ \\ {a}_{M} ( t )\end{matrix} ) = {Z}_{MxN - I}^{†} ( \begin{matrix}{s}_{1} ( t ) \\ {s}_{2} ( t ) \\ {s}_{3} ( t ) \\ ⋮ \\ {s}_{N - I} ( t )\end{matrix} )$$

Thus, the first antenna output signal is simply the first row of the partitioned transmission Moore-Penrose inverse matrix, Z^{†}_{M×N-I}, times the outputs of the collapsed signal vector. The second antenna output signal is simply the second row of the partitioned transmission Moore-Penrose inverse matrix times the outputs of the collapsed signal vector. The third antenna output signal is simply the third row of the partitioned transmission Moore-Penrose inverse matrix times the outputs of the collapsed signal vector. And so forth until all the antenna output signals are calculated. These antenna outputs will result in the transmission of the desired signals in the desired directions and null signals in other defined directions.

Although the present invention has been described as a mathematical method or process with little reference to the analog or digital domains, workers skilled in the art will recognize that changes may be made in form and detail without departing from the spirit and scope of the invention. For example, references to signals generally refer to down converted digitally sampled signals, however the method is general enough to work at analog carrier frequencies. Likewise, there are many wireless communication systems where spatial signal separation is important. These include cellular networks, military communications, and internet routers for local area or wide area networks.

1. A method of spatially separating N wireless communication reception signals using an array of M antenna, said method comprising:
(a) calculating signal time delays on antenna array from direction-of-arrival vectors and array geometry vectors
(b) constructing steering matrix (D) from time delays
(c) computing Moore-Penrose inverse matrix (Z) from steering matrix
Z=(D^{†}D)⁻¹D^{†}
(d) separating signals (s) by multiplying Moore-Penrose inverse matrix (Z) and antenna array signal vector (a)
$$( \begin{matrix}{s}_{1} ( t ) \\ {s}_{2} ( t ) \\ {s}_{3} ( t ) \\ ⋮ \\ {s}_{N} ( t )\end{matrix} ) = Z ( \begin{matrix}{a}_{1} ( t ) \\ {a}_{2} ( t ) \\ {a}_{3} ( t ) \\ ⋮ \\ {a}_{M} ( t )\end{matrix} )$$

2. A method of spatially separating signals as defined in claim 1, wherein said Moore-Penrose inverse matrix is partitioned such that only the rows corresponding to N−I valid wireless communication signals are included to only calculate valid signals. Said method comprising multiplying said partitioned matrix (Z_{N-I×M}) and antenna array signal vector (a) to yield separated signals of interest:
$$( \begin{matrix}{s}_{1} ( t ) \\ {s}_{2} ( t ) \\ {s}_{3} ( t ) \\ ⋮ \\ {s}_{N - I} ( t )\end{matrix} ) = {Z}_{N - IxM} ( \begin{matrix}{a}_{1} ( t ) \\ {a}_{2} ( t ) \\ {a}_{3} ( t ) \\ ⋮ \\ {a}_{M} ( t )\end{matrix} )$$

3. A method of spatially separating wireless transmitted communication signals using an antenna array, said method comprising:
(a) calculating time delays associated with antenna array geometry vectors and signal direction-of-transmission vectors
(b) constructing transmission steering matrix (D^{†}) from time delays
(c) computing transmission Moore-Penrose inverse (Z^{†}) from steering matrix
Z^{†}=(D D^{†})⁻¹D
(d) calculating antenna array signal vector (a) by multiplying transmission Moore-Penrose inverse (Z^{†}) and signals (s)
$$( \begin{matrix}{a}_{1} ( t ) \\ {a}_{2} ( t ) \\ {a}_{3} ( t ) \\ ⋮ \\ {a}_{M} ( t )\end{matrix} ) = {Z}^{†} ( \begin{matrix}{s}_{1} ( t ) \\ {s}_{2} ( t ) \\ {s}_{3} ( t ) \\ ⋮ \\ {s}_{N} ( t )\end{matrix} )$$

4. A method of spatially separating signals as defined in claim 3, wherein said transmission Moore-Penrose inverse matrix is partitioned such that only the columns corresponding to N−n valid wireless communication signals are included to calculate antenna array signal vector. Said method comprising multiplying said partitioned matrix (Z^{†}_{M×N-n}) and partitioned signal vector (s) to yield antenna output signals:
$$( \begin{matrix}{a}_{1} ( t ) \\ {a}_{2} ( t ) \\ {a}_{3} ( t ) \\ ⋮ \\ {a}_{M} ( t )\end{matrix} ) = {Z}_{MxN - n}^{†} ( \begin{matrix}{s}_{1} ( t ) \\ {s}_{2} ( t ) \\ {s}_{3} ( t ) \\ ⋮ \\ {s}_{N - n} ( t )\end{matrix} )$$
